(19) United States
(12) Patent Application Publication
(10) Pub. No.: US 2013/0036828 A1
(43) Pub. Date: Feb. 14, 2013

(54) FIXING JIG FATIGUE TESTING TEST PIECE, AND FATIGUE TESTING DEVICE

(71) Applicants: Yukari Kaga, Tokyo (JP); Isamu Iida, Kanagawa (JP); Fumio Okada, Kanagawa (JP); Masahiro Ishibashi, Tokyo (JP)

(72) Inventors: Yukari Kaga, Tokyo (JP); Isamu Iida, Kanagawa (JP); Fumio Okada, Kanagawa (JP); Masahiro Ishibashi, Tokyo (JP)

(73) Assignees: IHI INSPECTION & INSTRUMENTATION CO., LTD., Tokyo (JP); NEC CORPORATION, Tokyo (JP)

(21) Appl. No.: 13/642,599

(22) PCT Filed: Apr. 12, 2011
(86) PCT No.: PCT/JP2011/059471

§ 371 Date: Oct. 22, 2012

(30) Foreign Application Priority Data
Apr. 26, 2010 (JP) 2010-100573

(51) Int. Cl. G01N 3/02; G01N 3/32

(52) U.S. Cl. 73/795; 73/856

(57) ABSTRACT

Provided is a fixing jig including: a base configured to be mounted to a load axis of a fatigue testing device and including an accommodating recess portion for accommodating a portion to be held of a test piece; a pressing member disposed so as to be supported in the accommodating recess portion and configured to come into surface contact with an end surface of the test piece; and an insert nut configured to be threadedly engaged with a male screw portion of the portion to be held of the test piece. The fixing jig further includes a fastening flange including a hole portion for loosely inserting the test piece therethrough and a flange portion configured to come into contact with the insert nut, for holding the test piece in the accommodating recess portion via the insert nut so that the end surface of the test piece is pressed against the pressing member supported by the base.

### TECHNICAL FIELD

This invention relates to a fixing jig for a fatigue testing test piece and a fatigue testing device, and more particularly, to a fixing jig and a fatigue testing device suitable for a test of a material having a large anelastic deformation such as a plastic deformation.

### BACKGROUND ART

In general, as a method of evaluating a life of a material, a fatigue test is employed, which applies a load to a material in a repeated manner. Examples of this fatigue testing method include, when a direction of the load is a single axis, a method in which a displacement is repeatedly applied, a method in which a tensile load or a compressive load is constantly applied, and a method in which the direction of the load is repeatedly changed, such as a tensile-compressive load.

The fatigue test is performed in conformity with, for example, Non Patent Literature 1.

As the test piece, a test piece having a solid cylindrical shape is recommended, such as a so-called dumbbell-like shape illustrated in FIG. 1. A test piece 120 having this shape includes a small-diameter portion to be held 122 and a large-diameter portion to be held 123 having a diameter larger than that of the small-diameter portion to be held 122, which are formed on each of both ends of the test piece 120.

The test piece 120 is mounted on a fatigue testing device (FIG. 2 illustrates only a part of the fatigue testing device) by using a test piece fixing jig (hereinafter referred to as “fixing jig”) as illustrated in FIG. 2. Specifically, the large-diameter portion to be held 123 of the test piece 120 is placed on a recessed portion at the center of a mounter 330 formed at a distal end portion of a load axis portion 320 that is driven in an up-and-down direction in FIG. 2 by a driving source (not shown) of the fatigue testing device. A fastening flange 134, which is a fixing jig of the test piece, is fitted on the large-diameter portion to be held 123, and the large-diameter portion to be held 123 is fixed to the mounter 330 by using a bolt 135 and a nut 138. The load axis portion 320 is a part of the fatigue testing device, and is driven in the up-and-down direction in FIG. 2 by the driving source (not shown).

In a typical fatigue test, a tensile-compressive or tensile-tensile load is applied in a repeated manner in a longitudinal direction of the test piece. For this reason, in Non Patent Literature 1, it is described that an attention needs to be paid in design so that there is no backlash of the test piece with respect to the fatigue testing device when the direction of the load is reversed or a speed of a displacement is changed.

In addition to the fixing jig illustrated in FIG. 2, there are various types of fixing jigs for the fatigue testing test piece. In particular, as a fixing jig for fixing a test piece of which a portion to be held is formed into a solid cylindrical shape such as the test piece 120, there is a type of fixing jig which is divided into a plurality of parts to fix the test piece by uniformly fastening a periphery of the portion to be held from a circumferential direction of the portion to be held. There is another type of fixing jig which is divided into a plurality of parts and in which the test piece is fixed together with parts separated from the fatigue testing device in advance and then the combined fixing jig and test piece are fixed to a main unit of the fatigue testing device.

For example, in Patent Literature 1, a configuration is disclosed in which threads are processed on each of a portion to be held of a test piece and its corresponding fixing jig, and the test piece and the fixing jig are threadedly engaged to be fixed.

In Patent Literature 2, a configuration is disclosed in which a saw-blade-shaped protrusion formed on a fixing jig is fastened so that the protrusion digs into a portion to be held of a test piece to be fixed, the portion to be held having a smooth surface.

In Patent Literature 3, a configuration is disclosed in which a leaf spring is provided on a portion to be held at each of both ends of a test piece and the leaf springs are coupled to each other so that only an axial load is constantly applied to the test piece in a tensile load test.

In Patent Literature 4, a configuration is disclosed in which a spring is provided on an output axis of a driving unit (piston) that is coupled to a portion to be held of a test piece, and the load amount is adjusted by setting positions of the axis and the spring in advance.

In Patent Literature 5, a configuration is disclosed in which a damping member having an elastic modulus sufficiently smaller than that of a test piece is provided between a test piece fixing jig and the test piece, thereby enabling a test with high accuracy even when measuring a minute displacement by applying a minute load to the test piece.

In Patent Literature 6, a configuration is disclosed which adopts a structure in which a mounting piece is threadedly engaged with a female screw portion formed on a test piece holding block and a test piece is threadedly engaged with a female screw portion formed on the mounting piece so that a fatigue test of a small-sized test piece can be easily performed by mounting and removing the mounting piece with which the test piece is threadedly engaged and supporting various sizes of the test piece by adjusting a thread engagement depth of the mounting piece with respect to the test piece holding block.

### PRIOR ART LITERATURE

### Patent Literature

Patent Document 1: Japanese Unexamined Patent Application Publication (JP-A) No. Hei 7-174678

Patent Document 2: Japanese Unexamined Patent Application Publication (JP-A) No. 2005-337796

Patent Document 3: Japanese Unexamined Patent Application Publication (JP-A) No. Hei 6-323973

Patent Document 4: Japanese Unexamined Patent Application Publication (JP-A) No. 2003-75315

Patent Document 5: Japanese Unexamined Patent Application Publication (JP-A) No. Sho 62-285036

Patent Document 6: Japanese Unexamined Patent Application Publication (JP-A) No. Hei 7-92068

### Non Patent Literature

Non-Patent Document 1: “Standard Low Cycle Fatigue Testing for Solders” (JSMS-SD-3-00), Society of Materials Science, Japan (Incorporated Association)

### DISCLOSURE OF THE INVENTION

### Problem to be Solved by the Invention

When performing a mechanical characteristic test in which a force or a displacement generated by applying a load to a test piece is measured, it is necessary to fix and drive the test piece without causing a slip or a gap between the test piece and a fixing jig or between the fixing jig and a driving unit and to measure the displacement or the load in an accurate manner.

In both of Patent Literatures 1 and 2, a slip between the fixing jig and the test piece is prevented by increasing a contact area between the fixing jig and the test piece. However, in the case of a material having a large stress relaxation property or anelastic deformation such as a plastic deformation as represented by solder, even when the fixing jig is fastened by a bolt or the like or the protrusion is caused to dig into the test piece, the force is immediately relaxed, and hence it is difficult to fix the test piece while maintaining the tension. If the load direction is always constant such as in a tensile load test or a compressive load test, a slip hardly occurs between the fixing jig and the test piece although a fastening force is relaxed more or less, and a backlash hardly occurs. Therefore, the methods disclosed in Patent Literatures 1 and 2 are considered to be effective. However, in the fatigue test, the test piece is subjected to a plastic deformation between the test piece and a screw thread or the protrusion of the fixing jig, and hence it is considered that a backlash of the test piece is gradually increased when the load direction is reversed in a repeated manner.

In Patent Literature 3, although a backlash does not occur because a tension is constantly applied in a tensile load direction with respect to the fixing jig, in the fatigue test, it is considered that the backlash is gradually increased for the same reason as the above-mentioned case.

In Patent Literature 4, although a backlash between the driving unit and a main unit of the testing device can be possibly reduced also in the fatigue test because the spring force is exerted on the driving axis, a backlash of the test piece with respect to the fixing jig is not addressed.

In Patent Literature 5, the damping member may change the displacement of the test piece larger than an actual case, leading to a difficulty in an accurate measurement.

In Patent Literature 6, there is no effect of reducing a backlash of the test piece with respect to the fixing jig when the load direction is reversed.

In view of the above aspects, it is an object of this invention to provide a fixing jig for a test piece for a fatigue test in which an appropriate stress-strain hysteresis can be obtained without causing a backlash of the test piece with respect to the fixing jig when a load direction is reversed.

It is another object of this invention to provide a fatigue testing device including the above-mentioned fixing jig.

### Means to Solve the Problem

According to an aspect of this invention, there is provided a fixing jig for a test piece for a fatigue test, the test piece including a portion to be held having a male screw portion, the fixing jig including: a base configured to be mounted on a load axis of a fatigue testing device and including an accommodating recess portion for accommodating the portion to be held of the test piece; a pressing member disposed in the accommodating recess portion of the base so that the pressing member is supported by the base and configured to come into surface contact with an end surface of the test piece; an insert nut configured to be threadedly engaged with the male screw portion of the portion to be held of the test piece; and a fastening flange including a hole portion for loosely inserting the test piece therethrough and a flange portion configured to come into contact with the insert nut, for holding the test piece in the accommodating recess portion via the insert nut so that the end surface of the test piece is pressed against the pressing member supported by the base.

According to another aspect of this invention, there is provided a fatigue testing device including the fixing jig.

### Effect of the Invention

With the fixing jig according to this invention, a backlash of a test piece with respect to a fixing jig does not occur when a load direction is reversed in a fatigue test of a material having a large anelastic deformation, such as solder. Therefore, an accurate load detection can be performed and an excellent stress-strain (load-displacement) hysteresis (history) can be obtained.

In particular, even in a condition of a high temperature for which a fatigue test has been hardly performed so far, for example, a temperature about 30° C. lower than a melting temperature, it is possible to perform a fatigue test of solder.

### BRIEF DESCRIPTION OF THE DRAWINGS

FIG. 1 is a side view of an example of a test piece used in a standard fatigue testing.

FIG. 2 is a diagram illustrating a method of fixing the test piece in the standard fatigue testing.

FIG. 3 is a side view illustrating a partial cross section of a fixing jig for a test piece according to a first embodiment of this invention.

FIG. 4A is a side view of a pressing member used in the fixing jig illustrated in FIG. 3.

FIG. 4B is a bottom view of the pressing member used in the fixing jig illustrated in FIG. 3.

FIG. 5A is a side view illustrating a partial cross section of an insert nut used in the fixing jig illustrated in FIG. 3.

FIG. 5B is a top view of the insert nut used in the fixing jig illustrated in FIG. 3.

FIG. 6A is a side view of another example of the test piece used in the standard fatigue testing, which is to be fixed by the fixing jig according to this invention.

FIG. 6B is an end surface view of the other example of the test piece illustrated in FIG. 6A.

FIG. 7A is a graph showing stress-strain curves of various materials.

FIG. 7B is an enlarged graph showing the circular portion of FIG. 7A.

FIG. 8 is a graph showing stress-strain hystereses of test pieces of a solder material respectively obtained by using a fatigue testing device according to this invention including the fixing jig illustrated in FIG. 3 and a fatigue testing device according to a comparative example in which the fixing jig is not included.

FIG. 9A is a graph showing the stress-strain hystereses of the test piece of the solder material for the second compressive load-tensile load cycle and the 100th cycle and later according to this invention.

FIG. 9B is a graph showing the stress-strain hystereses of the test piece of the solder material for the second compressive load-tensile load cycle and the 100th cycle and later according to the comparative example.

FIG. 10 is a side view of a pressing member used in a fixing jig for a test piece according to a second embodiment of this invention.

FIG. 11 is a side view illustrating a partial cross section of a fixing jig for a test piece according to a third embodiment of this invention.

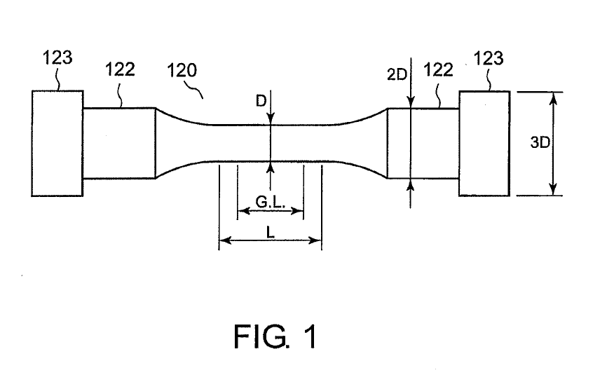

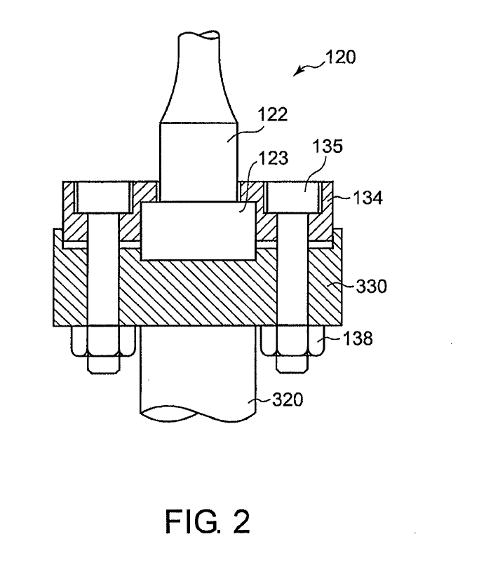

### MODE FOR CARRYING OUT THE INVENTION

A fixing jig for a test piece for a fatigue test according to this invention is intended for a test piece including a portion to be held on which a male screw portion (first male screw portion) is formed, and includes a base, a pressing member, an insert nut, and a fastening flange.

The base is configured to be mounted on a load axis of a fatigue testing device, and includes an accommodating recess portion for accommodating the portion to be held of the test piece. The pressing member is provided on a bottom surface of the accommodating recess portion of the base, and configured to come into surface contact with an end surface of the test piece. The insert nut is configured to be threadedly engaged with the male screw portion of the portion to be held of the test piece. The fastening flange includes a hole portion for loosely inserting the test piece therethrough and a flange portion configured to come into contact with the insert nut, and is configured to fasten the test piece to the base via the insert nut. The expression “loosely inserting” means that the test piece is inserted through the hole portion in a loose state.

With the above-mentioned configuration, the fixing jig according to this invention has the following operation effects when performing a fatigue test of a test piece of, for example, a solder material.

Solder generally has a large stress relaxation property, and its relaxation time is short. In addition, solder has a large plastic deformation (anelastic deformation) after a yield.

In the fatigue test, a constant displacement is applied to the test piece in a repeated manner. Therefore, the test piece is subjected to a tensile load and a compressive load in an alternating and repeated manner.

When a driving direction is reversed, a stress generated on the solder is immediately relaxed and decreased. However, the anelastic deformation cannot follow the reverse of the drive. As a result, a gap is generated between the test piece and the fixing jig for the test piece. This gap is gradually increased through repetition.

As described above, the process in which the gap is generated between the test piece and the fixing jig for the test piece does not depend on a size of a contact area between the test piece and the fixing jig. Therefore, this problem cannot be solved even by a method in which the test piece is threadedly engaged with the fixing jig or the test piece and the fixing jig are fixed to each other by a through hole or the like.

On the other hand, in the fixing jig for a test piece according to this invention having the above-mentioned configuration, the test piece and the pressing member are constantly held in contact with each other when a tensile load is applied, and hence there is no influence of a gap even when the drive is reversed to a compressive load. In addition, a dilation deformation of the portion to be held of the test piece in a circumferential direction thereof, which is generally considered to occur when a compressive load is applied, does not occur owing to a restraint by the insert nut, and because the test piece and the pressing member are held in contact with each other, there is no influence of the gap even at the time of the next reverse of the drive.

In the fixing jig for a test piece according to this invention, it is preferred that the pressing member and the insert nut each have an elastic modulus larger than that of the test piece such as solder. Alternatively, it is preferred that the pressing member and the insert nut be each made of stainless steel (for example, SUS304) or a titanium alloy.

Further, the pressing member may include a spring. In this case as well, it is preferred that the pressing member as a whole have an elastic modulus larger than that of the test piece.

Moreover, the pressing member may come into surface contact with the end surface of the test piece in the insert nut.

In addition, there may be adopted a configuration in which: the accommodating recess portion of the base includes a female screw portion; the pressing member includes a male screw portion (second male screw portion); and the pressing member is supported by the base in such a manner that a pressing load on the end surface of the test piece is adjustable by threadedly engaging with the female screw portion of the accommodating recess portion.

A fixing jig according to embodiments of this invention is described in detail below with reference to the accompanying drawings.

### First Embodiment

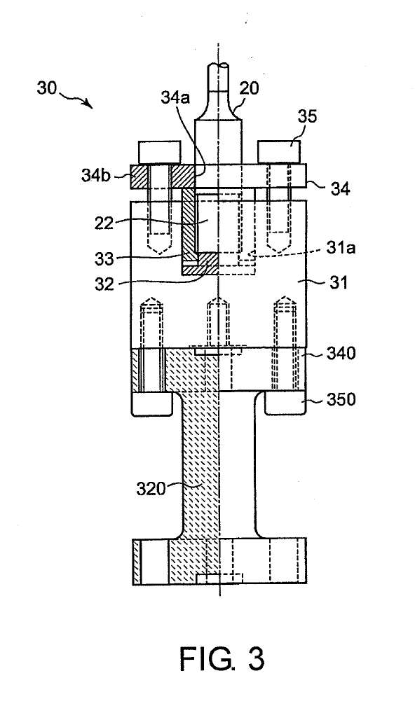

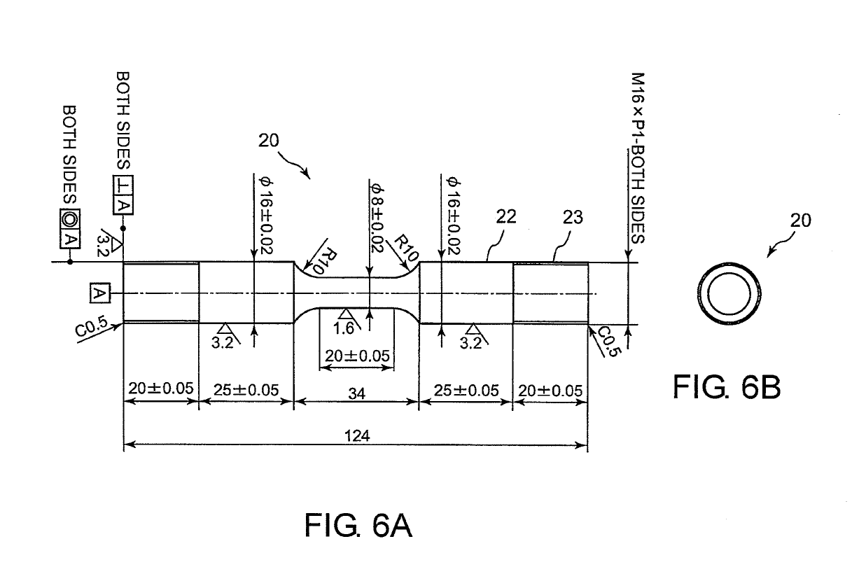

Referring to FIG. 3, a fixing jig 30 according to a first embodiment of this invention is intended for a test piece 20 illustrated in detail in FIG. 6A and FIG. 6B, and includes a base 31, a pressing member 32, an insert nut 33, and a fastening flange 34.

As illustrated in FIG. 6A and FIG. 6B, the test piece 20 has a dumbbell-like cylindrical shape, including a portion to be held 22 on which a male screw portion (first male screw portion) 23 is formed.

The base 31 has a substantially cylindrical shape, and is mounted on a mounter 340 formed an end portion of a load axis portion 320 of the fatigue testing device, which is partially illustrated in FIG. 3, with a bolt 350. The base 31 includes an accommodating recess portion 31a for accommodating the portion to be held 22 of the test piece 20. Although two bolts 350 are illustrated in FIG. 3, in this embodiment, eight bolts are actually used at regular intervals (45 degrees) along a circle.

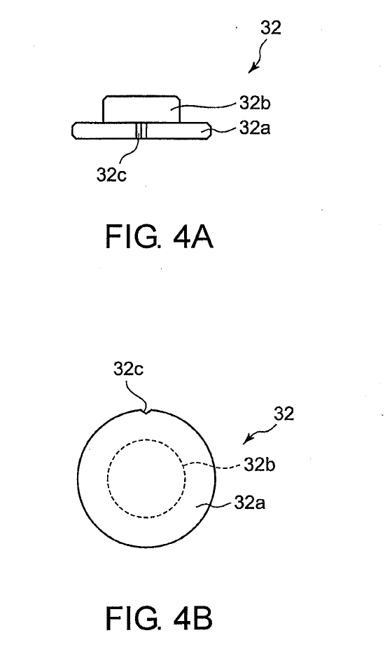

As illustrated in detail in FIG. 4A and FIG. 4B, the pressing member 32 has a substantially disk shape with a step, and includes a flange portion 32a and a protruded portion 32b. The pressing member 32 is disposed on a bottom surface of the accommodating recess portion 31a of the base 31 so that the flange portion 32a comes into contact with the bottom surface of the accommodating recess portion 31a, and a top surface of the protruded portion 32b comes into surface contact with the end surface of the test piece 20. A reference numeral 32c in FIG. 4A and FIG. 4B represents a notch for venting the air.

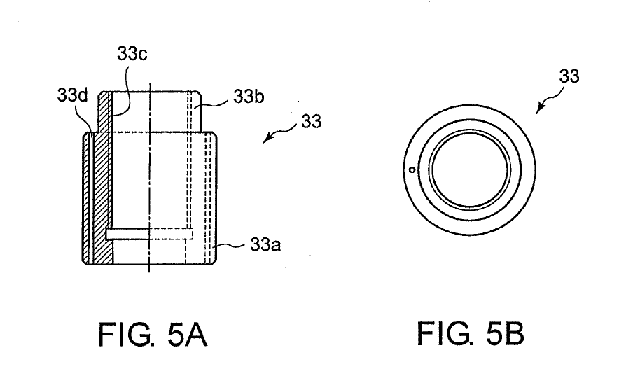

As illustrated in detail in FIG. 5A and FIG. 5B, the insert nut 33 has a substantially cylindrical shape with a step, and includes a large diameter portion 33a, a small diameter portion 33b, and a female screw portion 33c formed on an inner circumferential surface from the small diameter portion 33b to the large diameter portion 33a. The female screw portion 33c is threadedly engaged with the male screw portion 23 of the portion to be held 22 of the test piece 20. A reference numeral 33d in FIG. 5A and FIG. 5B indicates a hole for venting the air. The pressing member 32 comes into surface contact with the end surface of the test piece 20 in the insert nut 33.

It is preferred that the pressing member 32 and the insert nut 33 each have an elastic modulus larger than that of the test piece 20 such as solder. As a specific example of the material, in the case of the test piece of the solder, the elastic modulus of the solder is about 10 GPa to 70 GPa, and hence stainless steel or an iron-cobalt-chromium-nickel-based alloy having an elastic modulus of 200 GPa or larger, a titanium alloy having an elastic modulus of 88 Pa, or the like may be used as the material for the pressing member 32 and the insert nut 33. In addition, it is also preferred that the structural components of the fixing jig other than the pressing member 32 and the insert nut 33, i.e., the base 31, the fastening flange 34, a bolt 35, and the like each have an elastic modulus larger than that of the test piece 20 such as the solder.

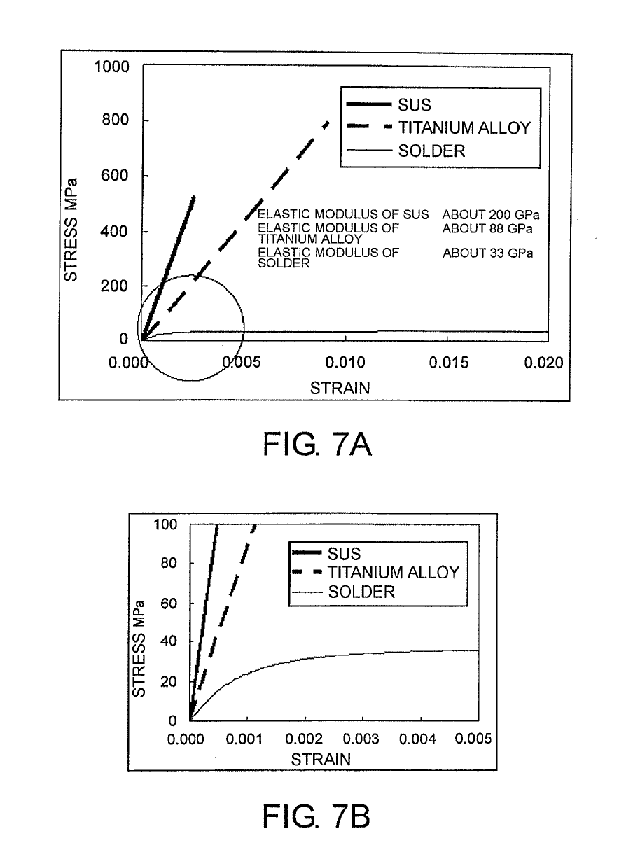

The elastic modulus of each material is shown in the stress-strain curves of the materials in FIG. 7A and FIG. 7B, where the elastic modulus of the solder is about 33 GPa, the elastic modulus of the stainless steel is about 200 GPa, and the elastic modulus of the titanium alloy is about 88 GPa at room temperature.

The stress of the fatigue test considered in this embodiment is up to about 100 MPa and about 10 MPa to 30 MPa on average. Therefore, even when the load is repeatedly applied to the pressing member 32 and the insert nut 33 made of the stainless steel or the titanium alloy, the original displacement is restored if the load is removed or the load is returned to zero if the displacement is returned to the origin. On the other hand, if the solder receives a load of 20 MPa to 30 MPa or larger, a permanent deformation is increased so that the original shape cannot be restored.

The fastening flange 34 has a substantially disk shape, includes a hole portion 34a for loosely inserting the test piece 20 therethrough and a flange portion 34b that comes into contact with the insert nut 33, and fastens the test piece 20 to the base 31 via the insert nut 33 by the bolt 35. Although two bolts 35 are illustrated in FIG. 3, in this embodiment, eight bolts are actually used at regular intervals (45 degrees) along a circle.

Although FIG. 3 illustrates only one end side of the test piece 20, actually, the same configuration is provided on both ends. A driving source (not shown) capable of performing a piston movement in the fatigue testing device is connected to one load axis, while the other load axis is fixed immovable.

The fixing jig 30 according to this invention has the following operation effects when performing a fatigue test of a material having a large anelastic deformation, such as solder, for example, when performing a fatigue test of the test piece 20 of the solder material owing to the above-mentioned configuration.

When the fatigue testing device on which the test piece 20 of the solder material is mounted by using the fixing jig 30 for the test piece starts its operation so that the test piece 20 receives a tensile load, a tensile stress is generated on the test piece 20 by which a strain (stretch) is generated. Usually, when the test piece 20 is stretched, a diameter of the test piece 20 is slightly decreased. However, the test piece 20 constantly receives a pressure by the pressing member 32, and hence there is no decrease of the diameter. Therefore, the test piece 20 is constantly held in contact with the insert nut 33.

Subsequently, when the test piece 20 receives a compressive load, a compressive stress is generated on the test piece by which a strain (contraction) is generated. Usually, when the test piece 20 is compressed, the diameter of the test piece 20 is slightly increased. However, the test piece 20 receives a pressure also from the insert nut 33 as well as from the pressing member 32, and hence there is no increase of the diameter.

After all, even when the reverse of the load is performed in a repeated manner, there is no gap occurring between the fixing jig 30 and the test piece 20.

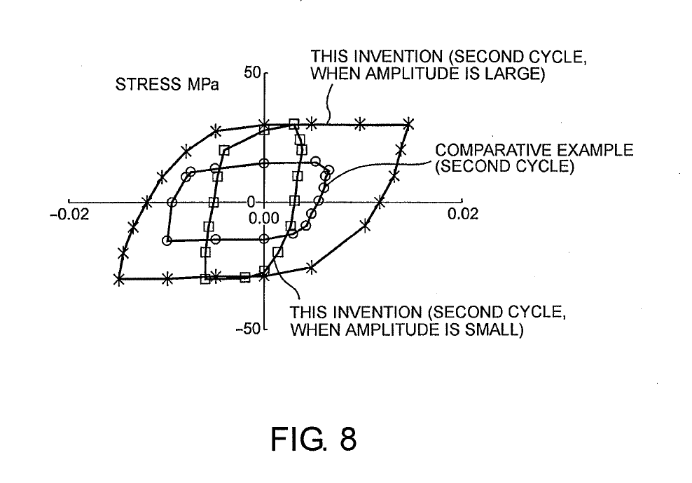

FIG. 8 shows, with regard to the test piece 20 of the solder material, a stress-strain hysteresis obtained by using a fatigue testing device including the fixing jig 30 according to this embodiment and a stress-strain hysteresis obtained by using a conventional fatigue testing device according to a comparative example which does not include the fixing jig 30. As is clear from FIG. 8, the stress-strain hysteresis according to this embodiment shows a virtually constant maximum stress even when a strain (deformation) amplitude on the horizontal axis is changed. On the other hand, in the stress-strain hysteresis according to the comparative example, the stress with respect to the strain is not sufficiently detected, which is estimated that a fixation of the test piece 20 is defective. All the hystereses shown in FIG. 8 are examples of measurements using the test piece 20 made of solder having the same composition at a temperature of 125° C. In FIG. 8, a hysteresis indicated by * represents a case where an amplitude is large at the second cycle of this embodiment, and a hysteresis indicated by □ represents a case where the amplitude is small at the second cycle of this embodiment. On the other hand, a hysteresis indicated by ∘ represents the second cycle of the comparative example.

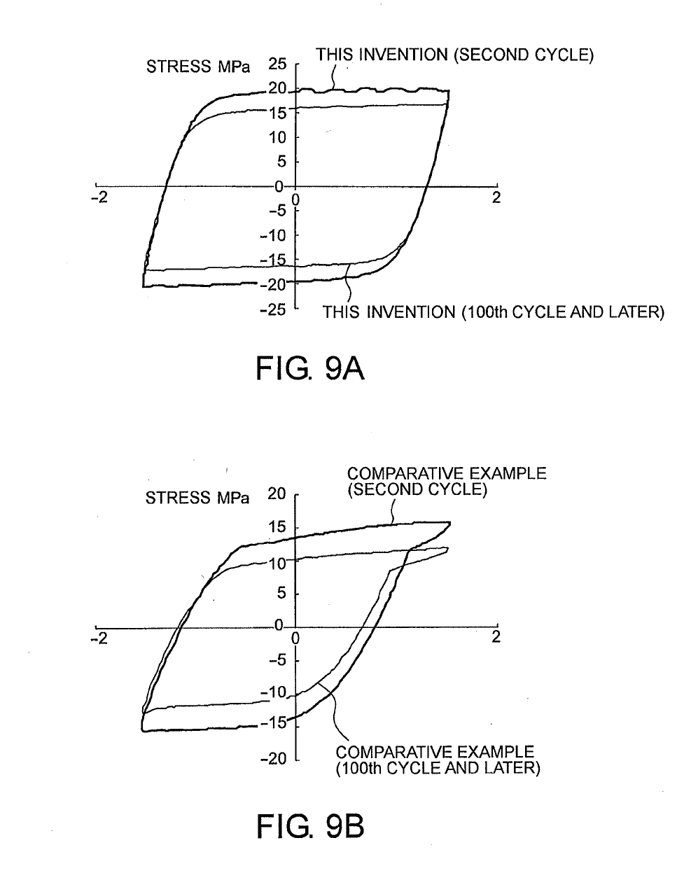

In FIG. 9A, the second compressive load-tensile load cycle using the fatigue testing device including the fixing jig 30 according to this embodiment is shown with a thick line, and the stress-strain hysteresis of the 100th cycle and later is shown with a thin line. As is clear from FIG. 9A, a behavior of a history in an area where the strain is reversed and starts to decrease from the maximum value is measured more accurately, which is not changed even when the number of cycles is increased.

In FIG. 9B, the second compressive load-tensile load cycle using the conventional fatigue testing device as the comparative example, which does not include the fixing jig 30, is shown with a thick line, and the stress-strain hysteresis of the 100th cycle and later is shown with a thin line. As is clear from FIG. 9B, an abnormal behavior of a history in an area where the strain is reversed and starts to decrease from the maximum value becomes conspicuous as the number of cycles is increased.

### Second Embodiment

A fixing jig according to a second embodiment of this invention is different from the fixing jig according to the first embodiment in a configuration of the pressing member. Therefore, a description of the same configuration as that of the first embodiment is omitted.

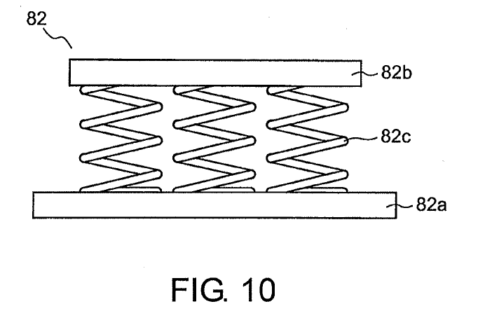

Referring to FIG. 10, a pressing member 82 includes a first flange portion 82a, a second flange portion 82b having a diameter smaller than that of the first flange portion 82a, and a coil spring 82c fixed between the first flange portion 82a and the second flange portion 82b. Although three coil springs 82c are illustrated in FIG. 10, in this embodiment, the three coil springs 82c are arranged at regular intervals (120 degrees) along a circle. In addition, it is preferred that a notch for venting the air be formed on the first flange portion 82a of the pressing member 82 in the same manner as the pressing member 32 according to the first embodiment.

The pressing member 82 is disposed on a bottom surface of the accommodating recess portion 31a of the base 31 (see FIG. 3) so that the flange portion 82a comes into contact with the bottom surface and a top surface of the protruded portion 82b comes into surface contact with the end surface of the test piece 20 (see FIG. 3), thus functions in the same manner as the pressing member 32 according to the first embodiment.

In the case of the pressing member having the above-mentioned configuration as well, it is preferred that the elastic modulus of the whole configuration be larger than that of the test piece.

### Third Embodiment

A fixing jig according to a third embodiment of this invention is different from the fixing jigs according to the first and second embodiments in a configuration of the pressing member. Therefore, a description of the same configuration as those of the first and second embodiments is omitted.

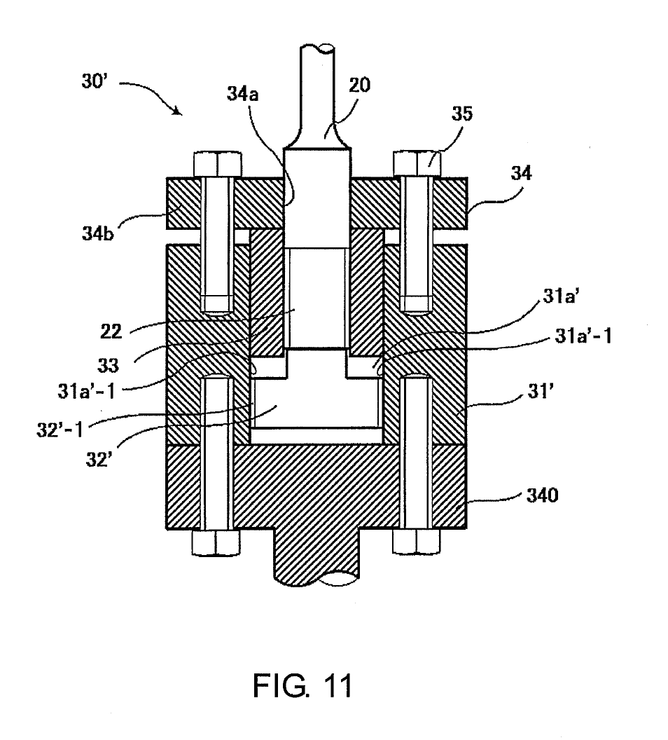

Referring to FIG. 11, in a fixing jig 30′ according to this embodiment, an accommodating recess portion 31a′ having a through hole shape is formed in a base 31′. A female screw portion 31a′-1 is formed in a predetermined range on a lower side of the accommodating recess portion 31a′ in FIG. 11. On the other hand, a male screw portion (second male screw portion) 32′-1 that is engageable with the female screw portion 31a′-1 of the accommodating recess portion 31a′ is formed on an outer circumferential surface of a pressing member 32′. The pressing member 32′ is supported by the base 31′ by threadedly engaging the pressing member 32′ with the female screw portion 31a′-1 from the lower side of the accommodating recess portion 31a′ in FIG. 11 before fixing the base 31′ to the mounter 340. By adjusting a depth of thread engagement of the pressing member 32′ with respect to the accommodating recess portion 31a′, it is possible to adjust the pressing load applied to the end surface of the test piece 20.

This invention has been described with reference to a plurality of embodiments so far. However, this invention is not limited to the above-mentioned embodiments. Regarding the configuration and the details of this invention, various modifications can be made, which can be understood by a person having an ordinary skill in the art, within a spirit and a scope of this invention recited in the following claims.

This application is based upon and claims the benefit of priority from Japanese Patent Application No. 2010-10573, filed on Apr. 26, 2010, the disclosure of which is incorporated herein in its entirety by reference.

### REFERENCE SIGNS LIST

20, 120 test piece

22 portion to be held

23 male screw portion

30, 30′ fixing jig

31, 31′ base

31a, 31a′ accommodating recess portion

32, 32′, 82 pressing member

33 insert nut

33a large diameter portion

33b small diameter portion

33c female screw portion

34 fastening flange

82a first flange portion

82b second flange portion

82c coil spring

320 load axis portion

330, 340 mounter

1. A fixing jig for a test piece for a fatigue test, the test piece including a portion to be held having a first male screw portion, the fixing jig comprising:
a base configured to be mounted on a load axis of a fatigue testing device and including an accommodating recess portion for accommodating the portion to be held of the test piece;
a pressing member disposed in the accommodating recess portion of the base so that the pressing member is supported by the base and configured to come into surface contact with an end surface of the test piece;
an insert nut configured to be threadedly engaged with the first male screw portion of the portion to be held of the test piece; and
a fastening flange including a hole portion for loosely inserting the test piece therethrough and a flange portion configured to come into contact with the insert nut, for holding the test piece in the accommodating recess portion via the insert nut so that the end surface of the test piece is pressed against the pressing member supported by the base.

2. A fixing jig according to claim 1, wherein the pressing member and the insert nut each have an elastic modulus larger than an elastic modulus of the test piece.

3. A fixing jig according to claim 1, wherein the pressing member and the insert nut are each made of stainless steel or a titanium alloy.

4. A fixing jig according to claim 1, wherein the pressing member comprises a spring.

5. A fixing jig according to claim 1, wherein the pressing member comes into surface contact with the end surface of the test piece in the insert nut.

6. A fixing jig according to claim 1, wherein:
the accommodating recess portion of the base includes a female screw portion;
the pressing member includes a second male screw portion configured to be threadedly engaged with the female screw portion; and
the pressing member is supported by the base in such a manner that a pressing load on the end surface of the test piece is adjustable by threadedly engaging with the female screw portion of the accommodating recess portion.

7. A fatigue testing device, comprising the fixing jig according to any claim 1.
